(19) United States
(12) Patent Application Publication
(10) Pub. No.: US 2010/0154568 A1
(43) Pub. Date: Jun. 24, 2010

(54) Analytical Instruments, Assemblies, and Methods

(76) Inventors: Michael J. Roth, Delphi, IN (US); James Mitchell Wells, Lafayette, IN (US); Ryan M. Danell, Greenville, NC (US)

Correspondence Address: WELLS ST. JOHN P.S., 601 W. FIRST AVENUE, SUITE 1300, SPOKANE, WA, 99201, US

(21) Appl. No.: 12/621,857

(22) Filed: Nov. 19, 2009

Related U.S. Application Data
(60) Provisional application No. 61/116,194, filed on Nov. 19, 2008.

(51) Int. Cl. G01N 1/20

(52) U.S. Cl. 73/863.71

(57) ABSTRACT

Sample inlet components are provided that can include a skimmer associated with a conduit, with the skimmer defining an opening configured to receive at least some sample exiting the conduit. The conduit can have a first end extending to a second end, with the first end configured as an entrance for the sample and the second end configured as an exit for the sample. The second end of the conduit can include at least two portions, a first portion of the two portions being located physically closer to the skimmer than a second portion of the two portions. Sample introduction methods are provided that can include propelling sample from a conduit aligned with an opening of a skimmer. The majority of the sample can exit the conduit in a direction other than toward the opening of the skimmer.

### CROSS-REFERENCE TO RELATED APPLICATION

This application claims priority to U.S. Provisional Patent Application Ser. No. 61/116,194 which was filed Nov. 19, 2008, entitled “Analytical Instruments, Assemblies, and Methods”, the entirety of which is incorporated by reference herein.

### GOVERNMENT RIGHTS STATEMENT

This invention was made with Government support under grant number 06-G-029 awarded by the Department of Homeland Security Transportation Security Laboratory (DHS-TSL). The government has certain rights in the invention.

### TECHNICAL FIELD

The present disclosure relates generally to analytical instruments, assemblies, and methods. Particular embodiments of the present disclosure relate to sample inlet components and/or sample introduction methods.

### BACKGROUND

Analytical instrumentation can be used to determine both qualitative and quantitative information about the composition of both inorganic and organic samples. Instrumentation such as mass spectrometry instrumentation can be used to determine the structures of a wide variety of complex molecular species. Additionally, mass spectrometry can be utilized to determine the structure and composition of solid surfaces as well.

As early as 1920, the behavior of ions in magnetic fields was described for the purposes of determining the isotopic abundances of elements. In the 1960's, a theory describing fragmentation of molecular species was developed for the purpose of identifying structures of complex molecules. In the 1970's, mass spectrometers and new ionization techniques were introduced providing high-speed analysis of complex mixtures and thereby enhancing the capacity for structure determination.

### SUMMARY

Sample introduction components are provided that can include a skimmer associated with a conduit, with the skimmer defining an opening configured to receive at least some sample exiting the conduit. The conduit can have a first end extending to a second end, with the first end configured as an entrance for the sample and the second end configured as an exit for the sample. The second end of the conduit can include at least two portions, a first portion of the two portions being located physically closer to the skimmer than a second portion of the two portions. The component can further include an electric field generating component aligned between the conduit and the skimmer.

Sample introduction methods are provided that can include propelling sample from a conduit aligned with an opening of a skimmer. The majority of the sample can exit the conduit in a direction other than toward the opening of the skimmer. The method can further include, after exiting the conduit, redirecting at least some of the sample toward the opening of the skimmer.

### BRIEF DESCRIPTION OF THE DRAWINGS

Embodiments of the disclosure are described below with reference to the following accompanying drawings.

FIG. 1 depicts a block diagram of an instrument according to an embodiment.

FIG. 2 is a component of the instrument of FIG. 1 according to an embodiment.

FIG. 3 is a simulation of use of a component of the instrument of FIG. 1 according to an embodiment.

FIG. 4 is a configuration of a component of the instrument of FIG. 1 according to an embodiment.

FIG. 5 is an example of the use of a component of the instrument of FIG. 1 according to an embodiment.

### DESCRIPTION

This disclosure of the invention is submitted in furtherance of the constitutional purposes of the U.S. Patent Laws “to promote the progress of science and useful arts” (Article 1, Section 8).

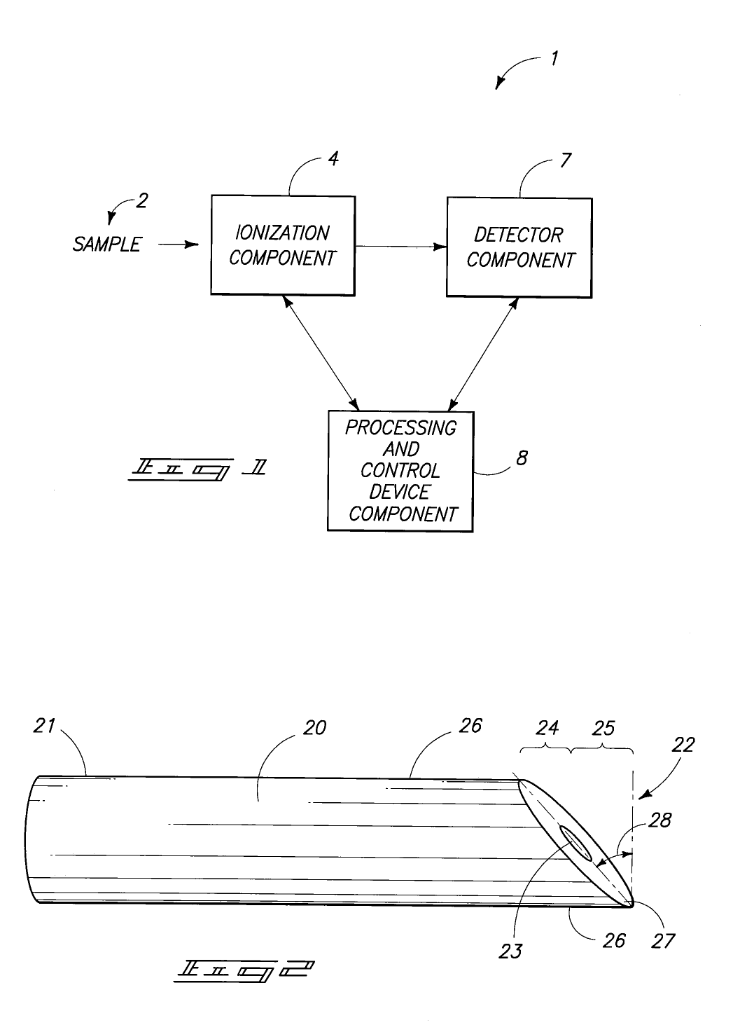

Example embodiments of the disclosure are described with reference to FIGS. 1-5. Referring to FIG. 1, an example instrument 1 is depicted that includes a sample inlet component 4 coupled to both a detector component 7 and a processing and control device component 8. In example embodiments, instrument 1 can be configured as a mass spectrometer by including a mass analyzer and/or separator component (not shown) between component 4 and detector component 7. Processing and control device component 8 can be coupled to one or more of components 4 and 7, as well as other components, including the mass analyzer component (not shown) and/or a sample preparation component such as a chromatography component. According to example configurations, component 4 can be used to provide sample of interest to various ion analyzing instrumentation, such as ionization components, mass separation components and/or detector component 7, when coupled to processing and control device component 8, for example. Example ion analyzing instrumentation that may be utilized include mass spectrometry instrumentation such as ion trap, quadruple MS, MS/MS, time-of-flight, sector, ICR and linear ion trap instruments.

Instrument 1 can be configured to receive a sample 2 and provide either or both of qualitative and/or quantitative data via processing and control device component 8, for example. Instrument 1 may also be configured as described in International Application No. PCT/US05/20783 filed Jun. 13, 2005, entitled “Analytical Instruments, Assemblies, and Methods”, and U.S. patent application Ser. No. 11/629,953 filed Jul. 24, 2007, entitled “Analytical Instruments, Assemblies, and Methods”, the entirety of which are incorporated by reference herein.

Sample 2 can be any chemical composition including either or both inorganic and organic substances in solid, liquid and/or vapor form as well as atomic species. Sample 2 can be a sample suitable for Atmospheric Pressure Ionization. Specific examples of samples suitable for analysis can include highly complex non-volatile protein based structures such as bradykinin. In certain aspects, sample 2 can be a mixture containing analytes, such as first and second analytes, and/or in other aspects sample 2 can be a substantially pure substance. Analysis of sample 2 will now be described with reference to aspects of sample inlet component 4.

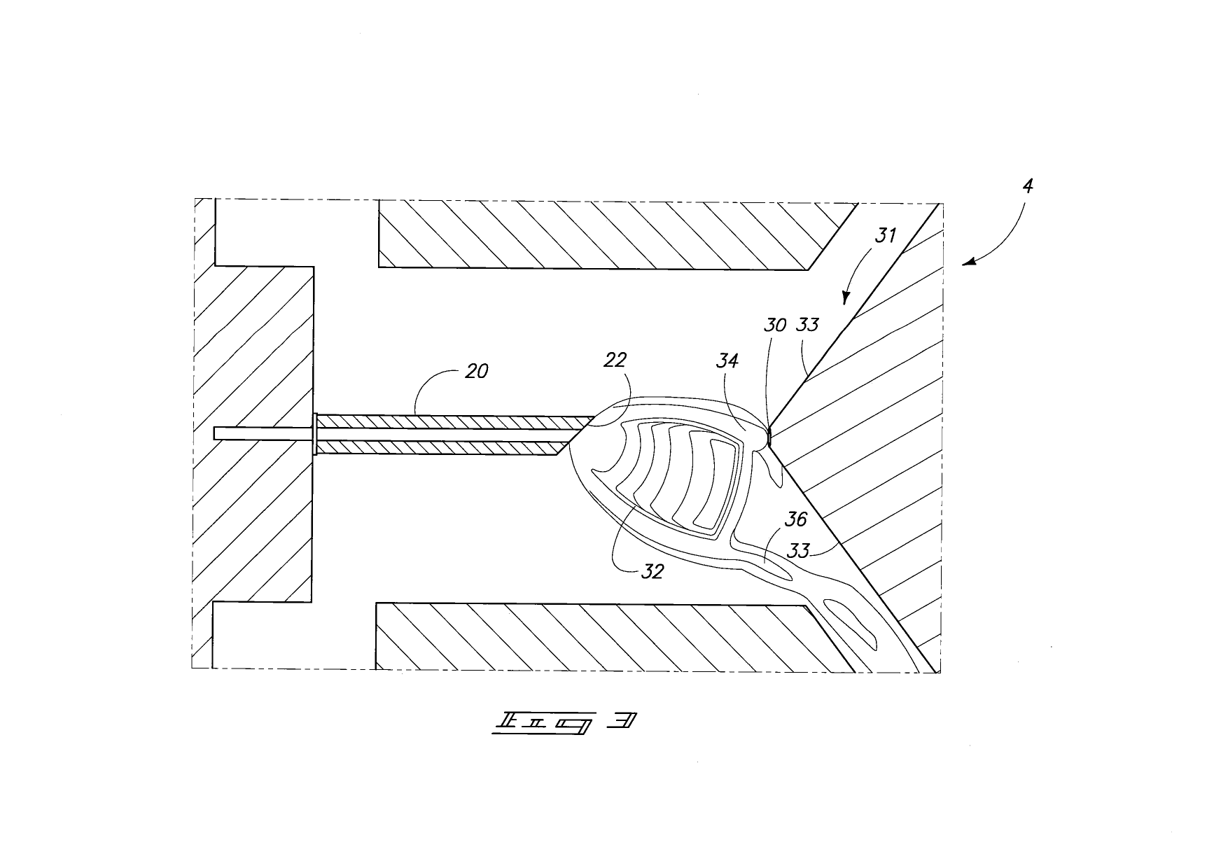

Referring to FIG. 2, a conduit 20 such as a capillary tube is shown having a first end 21 extending to a second end 22. Conduit 20 is included in component 4. First end 21 can be configured as an entrance to conduit 20 and may be configured to receive sample from sample preparation components such as chromatographs, traps, headspace analyzers and/or hand held sampling devices, for example. End 21 can also be configured to receive analyte from sample ionization components, such as electrospray ionization, desorption electro spray ionization, atmospheric pressure ionization, and/or laser desorption components. Second end 22 can be configured as an exit from conduit 20 having exit opening 23. In accordance with example implementations, exit opening 23 can take the form of an elliptical opening.

The second end 22 can include at least two portions, a first portion 24 and a second portion 25. In accordance with example embodiments, portion 24 can be located physically closer to first end 21 and portion 25. When associated with a skimmer, portion 25 may be located physically closer to the skimmer than portion 24.

Conduit 20 can also include sidewalls 26 which extend to a terminal face 27. Terminal face 27 can extend at an angle 28 other than normal to that of the edge defined by sidewall 26. In accordance with example implementations, terminal face 27 may be considered beveled in relation to the line of conduit 20. Conduit 20 can be constructed of metal, metal oxide, resistive material and/or a silica comprising material such as glass.

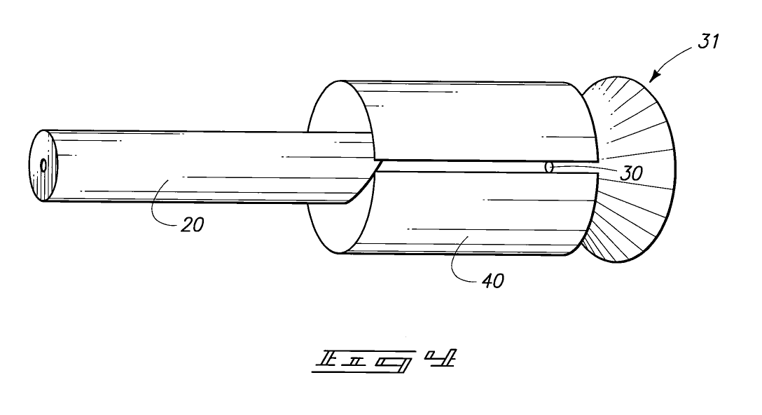

Referring to FIG. 3, conduit 20 can be configured as a part of component 4 to receive sample and provide same through end 22. Component 4 can include conduit 20 associated with a skimmer 31 within a chamber. Skimmer 31 can define an opening 30 and face 33. Opening 30 can provide access to an analytical component such as an ionization component, a mass separation component and/or detection component. In accordance with example implementations, face 33 can define at least a portion of a pathway to outside of the chamber.

Conduit 20 can be oriented in the general direction of receiving opening 30 and/or aligned directly with opening 30. Opening 30 and tube 20 can be housed within a chamber having a relatively constant pressure such as atmospheric pressure for example. The pressure within the chamber can also be from about 5 torr to about 50 mtorr.

Referring to FIG. 3, sample 32 is shown exiting conduit 20. Opening 30 can be aligned with an exit opening of conduit 20. As is shown in FIG. 3, a majority 36 of sample 32 can exit conduit 20 in a direction other than toward opening 30, while another portion 34 may exit conduit 20 and be provided to within opening 30. In accordance with example implementations, part of portion 34 may include analyte.

According to example implementations, a majority of sample 32 can be transferred from between conduit 20 and skimmer 31 to outside the chamber. Sample 32 can be propelled from an elliptical exit opening of conduit 20 toward skimmer 31. A majority of sample 32 can exit conduit 20 in a direction other that toward opening 30, and can be transferred to outside the chamber.

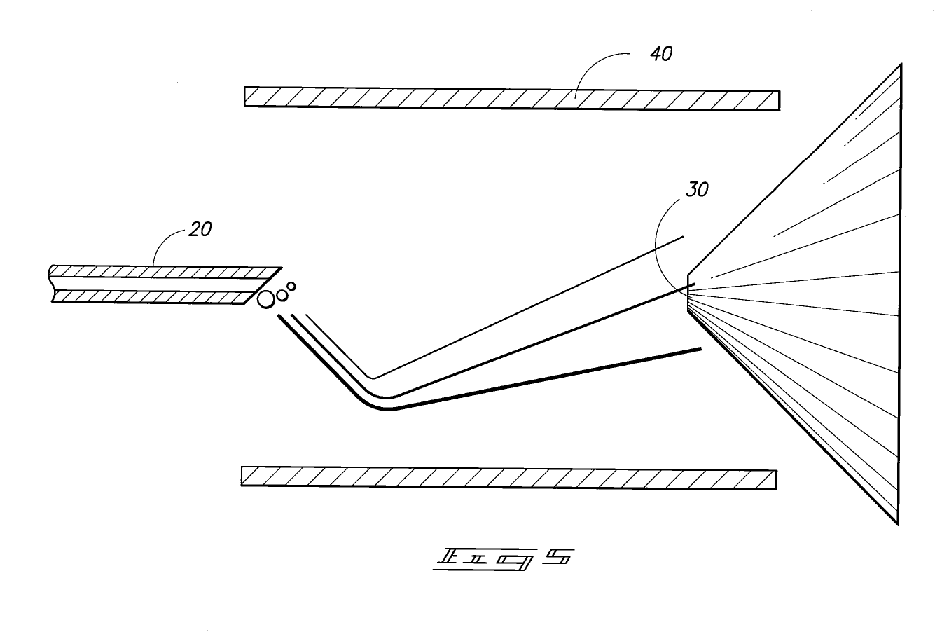

Referring to FIG. 4, component 4 can be configured with electric field generating component 40, such as a lens or lenses. Component 40 can be bifurcated cylindrical lenses and these lenses can be configured to provide an electric field such as a static DC field or a waveform to sample exiting conduit 20. According to example implementations, this field can be dictated by processing and control device component 8. The field can be applied to within the chamber housing conduit 20 and skimmer 31 and more particularly to a space between the exit of conduit 20 and opening 30.

Component 40 can extend from conduit 20 to skimmer 31. At least a portion of component 40 can overlap at least a portion of conduit 20 and/or skimmer 31.

Referring to FIG. 5, for the purposes of example only, a general path of sample is shown as manipulated from conduit 20 to opening 30 using component 40. As can be seen, both selecting and restoring voltages can be provided to sample exiting conduit 20. The voltages can alter the direction of sample portions, with certain portions being directed to opening 30 and other portions of sample being directed outside opening 30.

As mentioned above sample 32 can include charged analytes. After exiting conduit 20 in a direction other than that of opening 30, analytes can be redirected toward opening 30. In accordance with example implementations, it can be the application of an electrical field between the conduit and the skimmer that can provide for this redirecting.

Component 4 of instrument 1 can be utilized as an atmospheric pressure ionization (API) interface to a mass spectrometer. Conduit 20 can be a metal capillary inlet on axis with a conical metal “skimmer” opening 30 on the vacuum side, with the capillary cut at an angle or beveled on the vacuum side. Beveling conduit 20 can result in non-axial jet expansion from conduit 20 into the first vacuum stage. The gas may not be directed into opening 30 of the skimmer, but directed away from it. Ions traveling through conduit 20 can follow the path of the gas jet away from skimmer opening 30. Ions can be redirected toward opening 30 using a component 40 that encompasses the tip of conduit 20, the region between conduit 20, and the tip of the skimmer. The lens can be segmented to allow for redirection of ions toward skimmer orifice 30 by biasing an individual segment toward which the jet expansion occurs at a potential higher than another segment(s). The lens may also be cylindrical.

According to specific implementations, a reduction in gas conductance in the higher vacuum regions which lie beyond skimmer opening 30 by directing the gas jet away from the center of skimmer opening 30 while focusing ions through opening 30 using differential biasing on a segmented cylindrical lens may be achieved. Signal levels may be comparable to those obtained using a square-cut capillary and a symmetrically biased segmented cylindrical lens (i.e., all segments are at the same potential). Further, depending on the distance between conduit 20 and the skimmer, the segmented cylindrical lens may act as a low resolution mass filter, with data indicating a strong mass dependence using the offset between the halves of a two-segment cylindrical lens. Mass filtering capabilities within this region may be accomplished using this configuration for a mixture of components at short capillary-skimmer distances, while at greater distances, this configuration may demonstrate limited filtering capabilities but substantial ion transmission through the opening.

Instruments configured according to the present disclosure can prove particularly useful in combination with spectrometry instruments for the analysis of mixtures in circumstances where chromatography or other sample preparation components and separation techniques are not practical. Analytes may proceed to detector component 7 (FIG. 1). Example detector components include electron multipliers, Faraday cup collectors, photographic and scintillation-type detectors. The progression of analysis from component 4 to detector component 7 can be controlled and monitored by a processing and control device component 8. Example detector components also include those described in U.S. Pat. No. 7,161,142 issued Jan. 9, 2007, entitled “Portable Mass Spectrometers”, the entirety of which is incorporated by reference herein.

Processing and control device component 8 can contain data acquisition and searching software. In one aspect, such data acquisition and searching software can be configured to perform data acquisition and searching that includes the programmed acquisition of total analyte count. In another aspect, data acquisition and searching parameters can include methods for correlating the amount of analytes generated to predetermine programs for acquiring data. Example configurations of processing and control components include those described in International Patent Application No. PCT/US04/29029 filed Sep. 3, 2004, entitled “Analysis Device Operational Methods and Analysis Device Programming Methods”, and U.S. patent application Ser. No. 10/570,706 filed Jan. 26, 2007, entitled “Analysis Device Operational Methods and Analysis Device Programming Methods”, the entirety of both of which are incorporated by reference herein.

In one aspect such data acquisition and searching software can be configured to comprise acquisition and searching parameters that include the waveform provided to component 40 of component 4, corresponding mass spectra of compounds, and detection corresponding to component 40 waveform. In accordance with known database searching routines, processing and control unit 8 can identify compounds subjected to the analysis described herein. Typically instrument 1 can be calibrated with a known composition. Once calibrated, the instrument can provide mass spectra of analytes retained and released by component 4.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A sample inlet component comprising:
a skimmer associated with a conduit, the skimmer defining an opening configured to receive at least some sample exiting the conduit; and
the conduit having a first end extending to a second end, the first end configured as an entrance for the sample and the second end configured as an exit for the sample, the second end of the conduit comprising at least two portions, a first portion of the two portions being located physically closer to the skimmer than a second portion of the two portions.

2. The sample inlet component of claim 1 wherein the second end defines exterior walls of the conduit extending to a terminal face of the conduit, the terminal face of the conduit extending at an angle other than normal from at least one of the exterior walls.

3. The sample inlet component of claim 1 wherein the second end of the conduit defines a beveled end.

4. The sample inlet component of claim 1 wherein the skimmer is aligned in relation to the conduit to receive at least a portion of the sample from the second end.

5. The sample inlet component of claim 1 wherein the second end further defines an exit opening of the conduit, the exit opening being elliptical in shape.

6. A sample introduction method comprising propelling sample from a conduit aligned with an opening of a skimmer, the majority of the sample exiting the conduit in a direction other than toward the opening of the skimmer.

7. The introduction method of claim 6 further comprising receiving at least a portion of the sample through the opening of the skimmer.

8. The introduction method of claim 6 wherein the portion received through the opening of the skimmer comprises analyte.

9. The introduction method of claim 6 further comprising transferring the majority of the sample from between the conduit and the skimmer.

10. The introduction method of claim 9 wherein a majority of the sample is transferred past a face of the skimmer and to a vacuum system.

11. The introduction method of claim 6 further comprising propelling the sample from an elliptical opening of the conduit.

12. A sample inlet component comprising:
a skimmer associated with a sample introduction conduit, the skimmer defining an opening configured to receive at least some sample from the conduit;
the conduit having a first end extending to a second end, the first end configured as an entrance for sample and the second end configured as an exit for the sample, the second end of the conduit comprising at least two portions, a first portion of the two portions being located physically closer to the skimmer than a second portion of the two portions; and
an electric field generating component aligned between the conduit and the skimmer.

13. The sample inlet component of claim 12 wherein the skimmer defines a face defining at least a portion of pathway outside the ionization component.

14. The sample inlet component of claim 12 wherein the electric field generating component extends from the conduit to the skimmer.

15. The sample inlet component of claim 12 wherein at least a portion of the electric field generating component overlaps with one or both of the conduit and the skimmer.

16. The sample inlet component of claim 12 wherein the exit of the conduit is in line with the opening of the skimmer.

17. A sample introduction method comprising:
propelling sample from a conduit aligned with an opening of a skimmer, the majority of the sample exiting the conduit in a direction other than toward the opening of the skimmer; and
after exiting the conduit, redirecting at least some of the sample toward the opening of the skimmer.

18. The introduction method of claim 17 wherein the sample comprises charged analytes.

19. The introduction method of claim 18 further comprising redirecting at least some of the charged analytes toward the opening of the skimmer.

20. The introduction method of claim 17 wherein the redirecting comprises providing an electric field to the sample after it exits the conduit.

21. The introduction method of claim 20 wherein the electric field is in the form of a wave.

22. The introduction method of claim 20 wherein the electric field is a direct current electric field.
